(19) United States
(12) Patent Application Publication
(10) Pub. No.: US 2005/0012823 A1
(43) Pub. Date: Jan. 20, 2005

(54) Communication systems, camera devices, and communication methods

(76) Inventor: Kevin L. Young, Idaho Falls, ID (US)

Correspondence Address: Alan D. Kirsch;BBWI, PO Box 1625, IDAHO FALLS, ID, 83415-3899, US

(21) Appl. No.: 10/623,372

(22) Filed: Jul. 17, 2003

(51) Int. Cl. H04N 5/232; H04N 7/00; H04N 11/00

(52) U.S. Cl. 348/211.2; 348/552

(57) ABSTRACT

Aspects of the invention relate to communication systems configured to communicate information in real-time between remote locations, and communication methods. In one aspect, a communication system configured to communicate information in real-time between remote locations is disclosed. The communication system includes a portable camera apparatus having a video camera configured to capture and transmit video signals between remote locations. A receiver apparatus is configured to receive video signals transmitted by the camera apparatus. The receiver apparatus is configured to scan the received video signals and establish a lock on a video signal having a highest signal strength among the video signals received by individual ones of antennas of an antenna array of the receiver apparatus.

### GOVERNMENT RIGHTS

This invention was made with Government support under Contract No. DE-AC07-99ID13727 awarded by the U.S. Department of Energy. The Government has certain rights in the invention.

### TECHNICAL FIELD

Aspects of the invention generally relate to communication systems, camera devices, and communication methods. More particularly, aspects of the invention relate to camera systems and methodologies for use in hazardous environments.

### BACKGROUND OF THE INVENTION

Police and emergency response organizations, when confronted with hazardous mishaps, may be required to undertake quick and decisive actions to gain control of the situation and protect the public. Such situations typically involve coordination with other agencies. The ability to quickly gain control over the situation from the perspective of the police organization's role is crucial, as is the ability to prioritize necessary actions and implementation of such required actions in an orderly manner.

Perception of a hazardous environment is important as exact positions in the environment is a-priori unknown and changing during a mission. When direct sight of the hazardous environment and actions performed by rescue teams is not available, a portable camera system may be the only means for personnel monitoring the rescue teams to assess the hazardous environment acted upon by the rescue teams. The quality of images and the number of point of views available using the portable camera system often determines what can realistically be achieved by the rescue teams.

In one approach, Remote Surveillance Systems (RSS) having video monitoring, audio communications, and telemetric data management provide active monitoring of tasks performed in a hazardous environment. Sensory devices transmit video, audio and telemetric signals to a monitoring station. Trained personnel may then supervise controlled network activities from the monitoring station. Several monitoring stations may be established through a controlled area based on preference and work activity.

One practical limitation of RSS is physical connection with the monitoring station. In most cases, the RSS is linked to the monitoring station via cables. These cables have to be managed through specially-designed equipment to insure proper deployment of the RSS within its environment. An ill-designed cable management system can impair rescue tasks from being efficiently executed.

In another approach, helmet mounted wireless camera systems were used by personnel entering hazardous environments. Information gathered by a helmet mounted camera system was transmitted to a remote location for surveillance. However, helmet mounted camera systems are cumbersome and difficult to use in combination with hazardous protective suits (e.g., bubble suits) worn by personnel entering a hazardous environment. The hazardous protective suits may have to completely encapsulate the users to offer protection from various hazardous conditions.

Furthermore, traditional wireless cameras having a receiver with a single antenna are more likely to encounter signal interference, known as multi-pathing, which may cause degradation of received images. Furthermore, users of a hand-held wireless camera may be constantly moving, thereby compounding signal degradation.

Thus, it is desirable to have a wireless video camera system that avoids some or all of the above-noted problems.

### SUMMARY OF THE INVENTION

Aspects of the invention relate to communication systems configured to communicate information in real-time between remote locations, camera devices, and communication methods.

In one aspect, a communication system configured to communicate information in real-time between remote locations is disclosed. The communication system includes a portable camera apparatus having a video camera configured to capture video signals. The video camera includes a voltage regulator for regulating voltage received from a battery source and providing a regulated voltage to the video camera. The video camera may also include a transmitter configured to transmit the video signals captured by the video camera from one location to another remote location. The camera apparatus includes a receiver apparatus having an antenna array with a plurality of antennas, wherein individual antennas are configured to receive video signals transmitted by the transmitter. The receiver apparatus includes a receiver device and is configured to be disposed adjacent the antenna. The receiver apparatus is configured to scan the video signals received by individual antennas and establish a lock on a video signal in response to signal strength of the respective video signals received by individual ones of the antenna array.

In another aspect, a communication system is disclosed. The communication system includes a portable camera apparatus having a video camera configured to capture signals, and a transmitter configured to transmit the video signals captured by the video camera. The communication system includes a receiver apparatus having an antenna array including a plurality of antennas, wherein individual ones of the antenna array are configured to receive the video signals transmitted by the transmitter. The receiver apparatus includes a receiver device disposed adjacent the antenna. The receiver device is configured to establish a lock on a video signal having a highest signal strength from among the video signals received by individual ones of the antenna array, and wherein the video signals from the transmitter are transmitted at a frequency of about 900 MHz.

In another aspect, a communication method for communicating information in real-time between remote locations is described. The method includes regulating voltage received from a battery source provided in a portable video camera, providing a regulated voltage to the video camera, capturing video signals using the video camera, transmitting the video signals using a transmitter, providing an antenna array having a plurality of antennas to receive the video signals transmitted by the transmitter, and scanning the received video signals using a receiver device disposed adjacent the antenna array. The receiver device may be configured to scan individual ones of the antenna array and establish a lock onto a video signal having a highest signal strength from among the received video signals.

In yet another aspect, a communication method for communicating information between remote locations is described. The method includes capturing signals using a video camera, transmitting the captured signals using a transmitter comprised in the video camera, receiving the video signals transmitted from the video camera using an antenna array having a plurality of antennas, providing a receiver device adjacent the antenna array, scanning the video signals received by the antennas to determine a video signal having a highest signal strength among the received video signals, and locking onto a video signal having the highest signal strength. The video signals from the transmitter are transmitted at a frequency of about 900 MHz.

In a further aspect, a method of remotely monitoring a hazardous environment is described. The method includes providing a water-proof camera apparatus in the hazardous environment to capture and transmit video signals of the hazardous environment. The transmitted video signals are received in a receiver apparatus via an antenna array having a plurality of antennas. Video signals received by the individual ones of the antenna array are scanned to establish a lock on a video signal having a highest signal strength among the received video signals.

### BRIEF DESCRIPTION OF THE DRAWINGS

Preferred embodiments of the invention are described below with reference to the following accompanying drawings.

FIG. 1 is a high-level block diagram of a communication system in accordance with some embodiments of the present invention.

FIG. 2 is a high-level block diagram of a communication system in accordance with other embodiments of the present invention.

FIG. 3 is a block diagram of a camera apparatus shown in FIGS. 1-2.

FIG. 4 is a block diagram of a receiver apparatus shown in FIG. 1.

FIG. 4A is a block diagram of a receiver apparatus shown in FIG. 2.

FIG. 5 is a schematic of a power-relay unit configured to supply power to the receiver apparatuses shown in FIGS. 4-4A in accordance with some embodiments.

FIG. 6 is a block diagram of an extension link receiver apparatus shown in FIG. 2.

FIG. 7 is a block diagram of a monitoring unit shown in FIGS. 1-2.

FIG. 8 is a flowchart describing a methodology of transmitting video signals between remote locations according to some embodiments.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

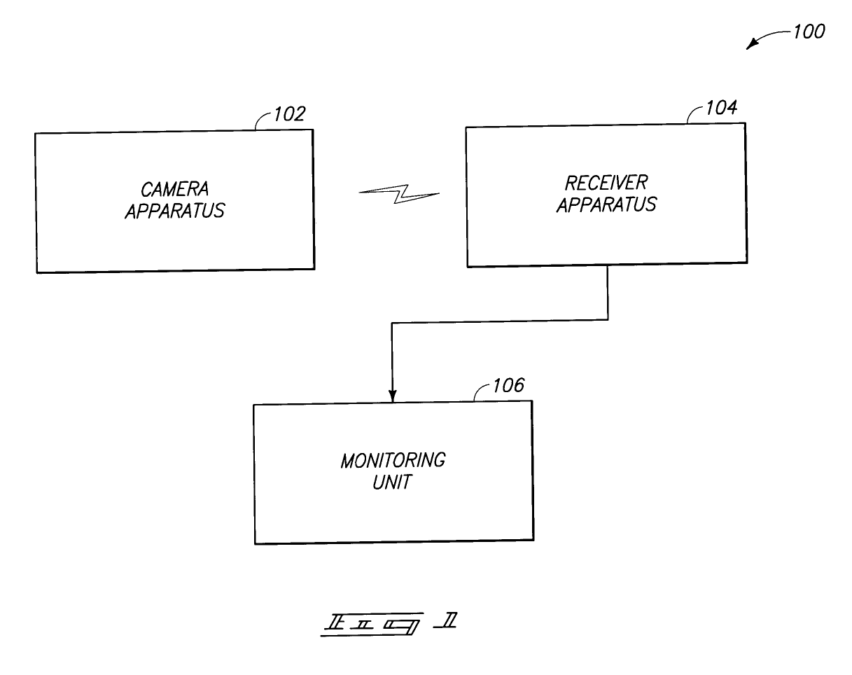

FIG. 1 is a high-level schematic of a communication system 100 according to one embodiment of the present invention. Communication system 100 includes a camera apparatus 102, a receiver apparatus 104, and a monitoring unit 106.

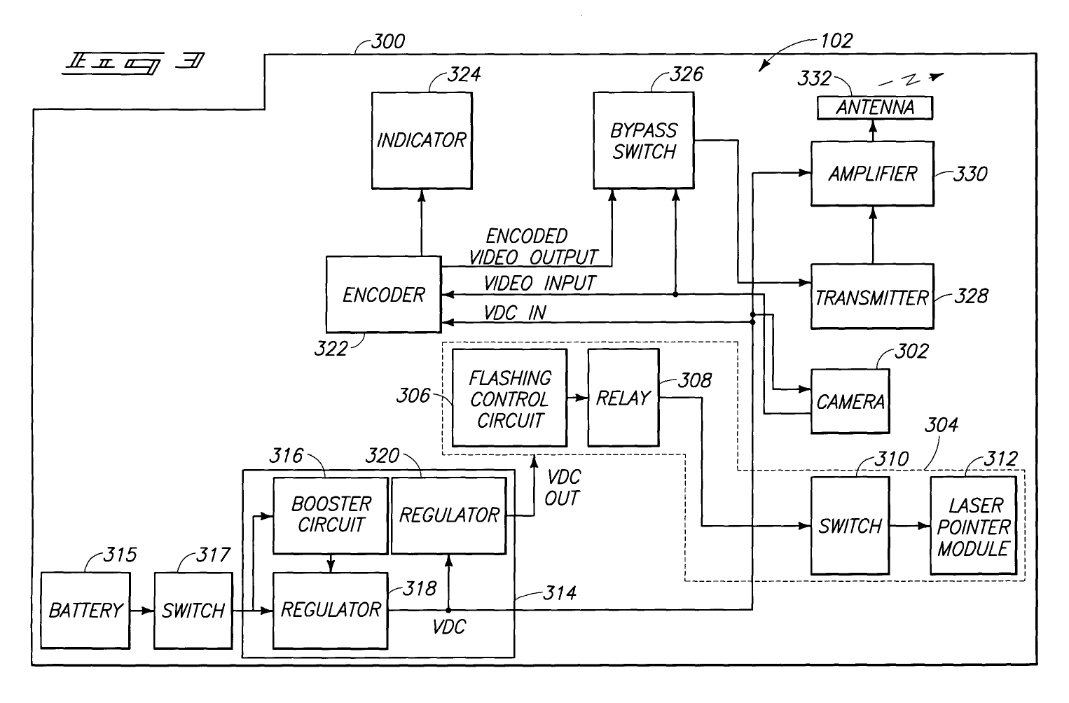

Camera apparatus 102 may be a video camera configured to capture and transmit video data/signals in real-time to receiver apparatus 104. In an exemplary embodiment, camera apparatus 102 is in wireless communication with receiver apparatus 104. For example, video signals captured by the camera apparatus 102 may be transmitted from the camera apparatus 102 to the receiver apparatus 104 in the form of radio frequency (RF) signals. Further details regarding the camera apparatus 102 are set forth below with regard to FIG. 3.

Receiver apparatus 104 is configured to receive video signals transmitted from the camera apparatus 102. In one exemplary embodiment, camera apparatus 102 and receiver apparatus 104 are configured to have a communication range of up to about 2200 feet line-of-sight without encountering degradation in signal reception of video signals transmitted from the camera apparatus 102.

Monitoring unit 106 is configured to receive video signals from the receiver apparatus 104 for monitoring purposes by personnel located remote from a location of the camera apparatus 102. In one exemplary case, communication between receiver apparatus 104 and monitoring unit 106 may be implemented via a cable. Other modes of communication (e.g., wireless communication) between receiver apparatus 104 and monitoring unit 106 are possible.

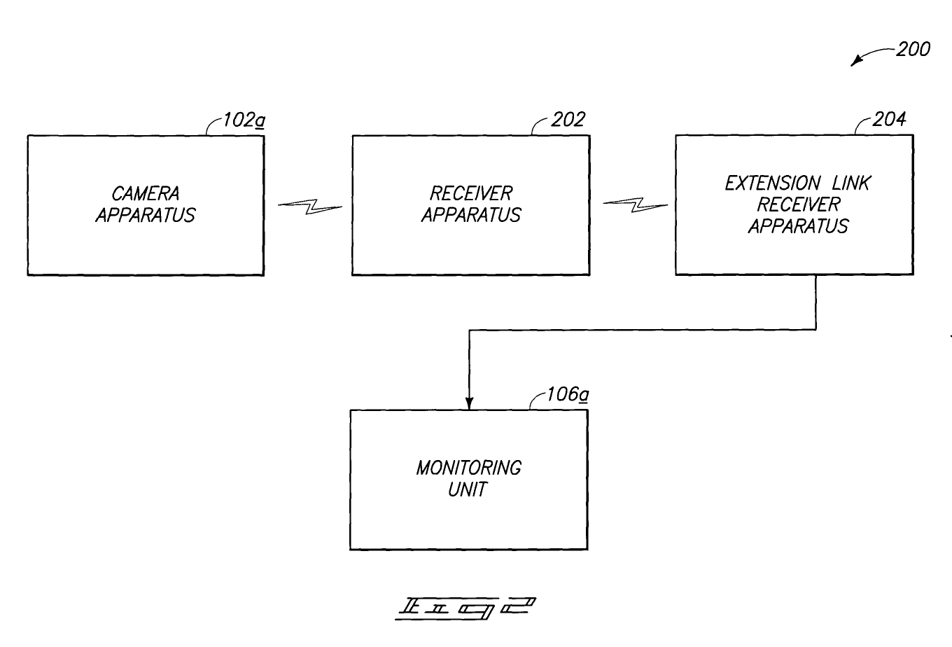

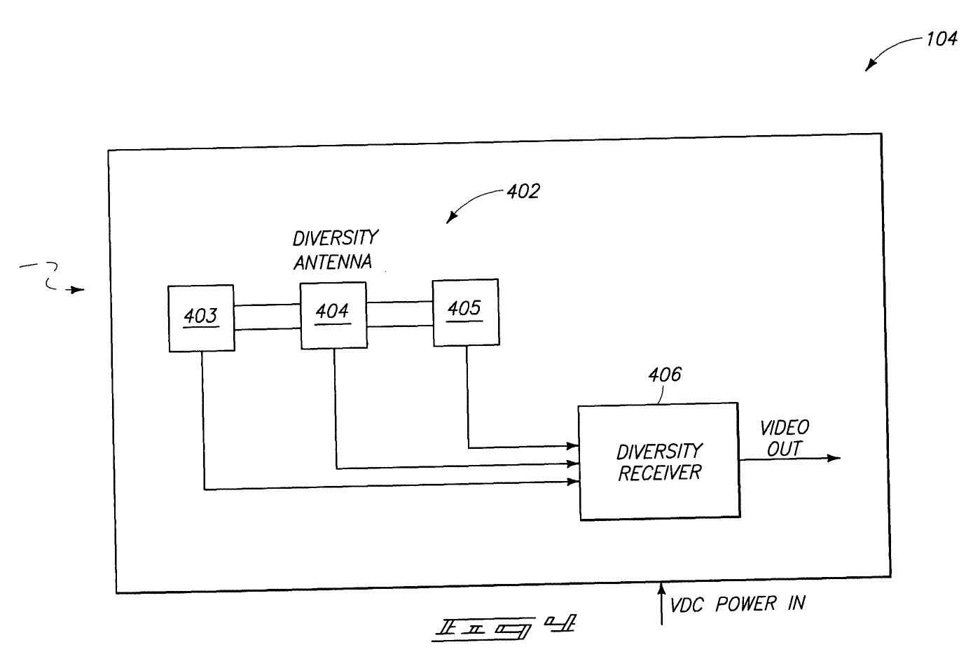

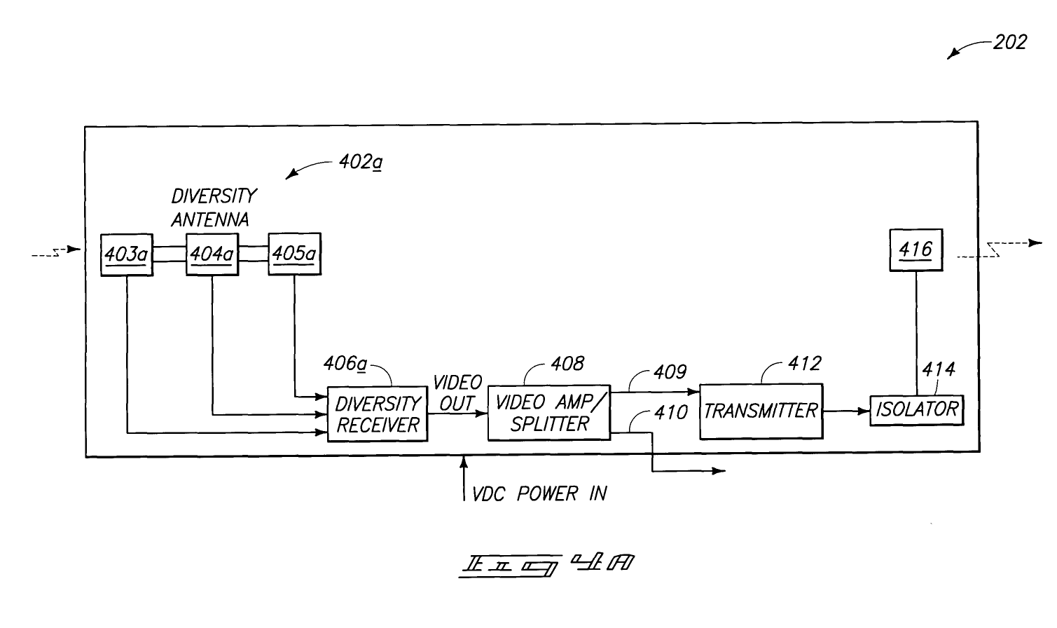

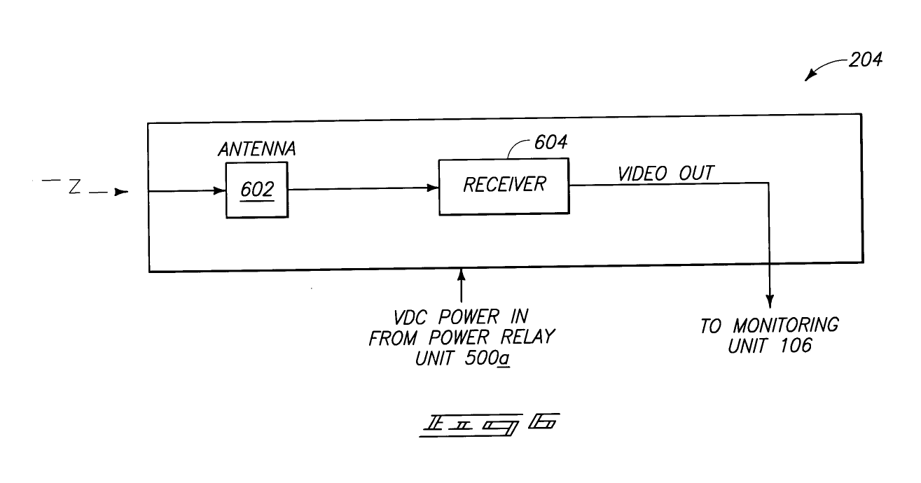

FIG. 2 is a high-level schematic of a communication system 200 in accordance with another embodiment wherein like elements shown in FIG. 1 are identified using like numerals, but with a suffix “a” added. Communication system 200 includes a camera apparatus 102a, a receiver apparatus 202, an extension link receiver apparatus 204, and a monitoring unit 106a. Video signals transmitted from the camera apparatus 102a and received by the receiver apparatus 202 may be further transmitted from the receiver apparatus 202 for reception by the extension link receiver apparatus 204. Video signals received by receiver apparatus 204 are provided for monitoring and display using the monitoring unit 106a. In one case, transmission range between receiver apparatus 202 and extension link receiver apparatus 204 is greater than about 4 miles line-of-sight. Further details of the receiver apparatus 202 are set forth below at FIG. 4A and details of extension link receiver apparatus 204 are set forth at FIG. 6.

In another embodiment, video signals received by the receiver apparatus 202 may be split into a plurality of paths (e.g., first and second paths). Video signals split into the first path may be provided to a first monitoring unit (e.g., such as monitoring unit 106), and video signals split into the second path may be further transmitted to a further remote location for reception by the receiver apparatus 204 and provided to the monitoring unit 106a.

FIG. 3 is a block diagram schematic of camera apparatus 102 shown in FIG. 1. Camera apparatus 102 may be disposed in a housing 300. For example, housing 300 may be a waterproof housing. The housing 300 may be made of plastic. Other lightweight yet waterproof materials may also be used. Camera apparatus 102 includes a camera 302, laser flashing apparatus 304, a voltage regulator 314, a video encoder 322, an indicator 324 (e.g., encoder mode indicator), a bypass switch 326, (e.g., encoder bypass switch), a transmitter 328 (e.g., video transmitter), an amplifier 330 (e.g., radio frequency (RF) amplifier), and antenna 332. Components of the camera apparatus 102 listed herein are exemplary, and as such, more or less components may be utilized to achieve aspects of the invention without deviating from the scope of the various aspects of the invention.

Camera 302 may be a color video camera configured to capture video data. Camera 302 is alternatively referred to as video camera. For example, the camera 302 may be a model VB21CSHRX-W36 available from Marshall Electronics. In one exemplary embodiment, video camera 302 may include laser flashing apparatus 304.

Laser flashing apparatus 304 includes flashing control circuitry 306 (e.g., flashing control circuit using a 555 timer integrated circuit), relay 308 (e.g., solid state relay), a switch 310, and a light source 312 (e.g., laser pointer module). The light source 312 may be used to identify a frame of reference (e.g., center) of an image, captured by the camera 302, to assist a user monitoring images captured by the camera 302. The control circuitry 306 is configured to control flashing (e.g., periodically turning-on and turning-off) of the light source 312 in order conserve energy drawn from a DC voltage source, such as battery 315. The battery 315 may be provided with a switch 317 to control supply of energy to various components of the camera apparatus 102. In an exemplary embodiment, relay 308 and switch 310 may be used to control flashing of the light source 312.

Voltage regulator 314 is configured to receive input voltage from the battery 315 and provide a regulated output voltage to various components of the video camera apparatus 102. In one embodiment, regulator 314 includes a booster circuit 316 configured to boost received input voltage from battery 315 from a first level to a second higher level. Voltage regulator 314 also includes regulator devices 318, 320 to generate different regulated output voltages for supply to various components of the camera apparatus 102. For example, regulator 318 may be configured to receive input voltage from the battery 315 and produce a first regulated output voltage (e.g., 12 volts) supplied to camera 302 and amplifier 330. Regulator 320 may be configured to receive the first regulated output voltage from regulator 318 and produce a second regulated output voltage (e.g., 5 volts) that may be used by the laser flashing apparatus 304.

Encoder 322 is configured to encrypt video signals received from the video camera 302. The bypass switch 326 may be selectively set to be in one of two modes (e.g., an encrypted mode, or a bypass mode). If the bypass switch 326 is set to operate in encrypted mode, video signals from the video camera 302 are fed to encoder 322 for encryption, and encrypted video signals output from encoder 322 are fed to transmitter 328 via bypass switch 326. However, if the bypass switch is set to operate in a bypass mode, video signals from the video camera 302 are fed directly to the transmitter 328 via bypass switch 326 bypassing the encoder 322. An indicator device 324 is provided to indicate (e.g., flash green) when video signals from the video camera 302 are encrypted by the encoder 322 prior to transmission by the transmitter 328.

Transmitter 328 is configured to transmit video signals (e.g., either encrypted video signals received from encoder 322 or unencrypted video signals from the camera device 102). In one embodiment, transmitter 328 is configured to convert video signals (e.g., encrypted video signals as well as unencrypted video signals) to RF signals, and the RF signals may be amplified using amplifier 330 (e.g., RF amplifier) prior to transmission via antenna 332 (e.g., whip antenna). In one exemplary embodiment, amplified RF signals may be transmitted using transmitter 328 at a frequency of about 900 MHz and at a power level of about 200 mW. Other transmission frequencies and power levels are possible.

FIG. 4 is a block diagram schematic of receiver apparatus 104 according to one embodiment. The receiver apparatus 104 includes an antenna array 402, and a receiver 406.

The receiver apparatus 104 may be configured to receive RF signals (e.g., encrypted or unencrypted) transmitted from the camera apparatus 102. Antenna array 402 may be a triple-diversity antenna array having a plurality of antennas (e.g., patch antennas) 403, 404, 405. In one case, gain of individual patch antennas 403, 404, and 405 is at least 8 dB. RF signals received by antenna array 402 are fed to a receiver 406. The receiver 406 may be a true-diversity receiver configured to scan the RF signals received by the plurality of antennas 403, 404, 405 to determine an RF signal having increased signal strength among the RF signals received by individual antennas 403, 404, 405, respectively. Receiver 406 is configured to establish a lock on a RF signal determined to have increased signal strength. The receiver 406 is further configured to convert the locked RF signal into a composite video signal.

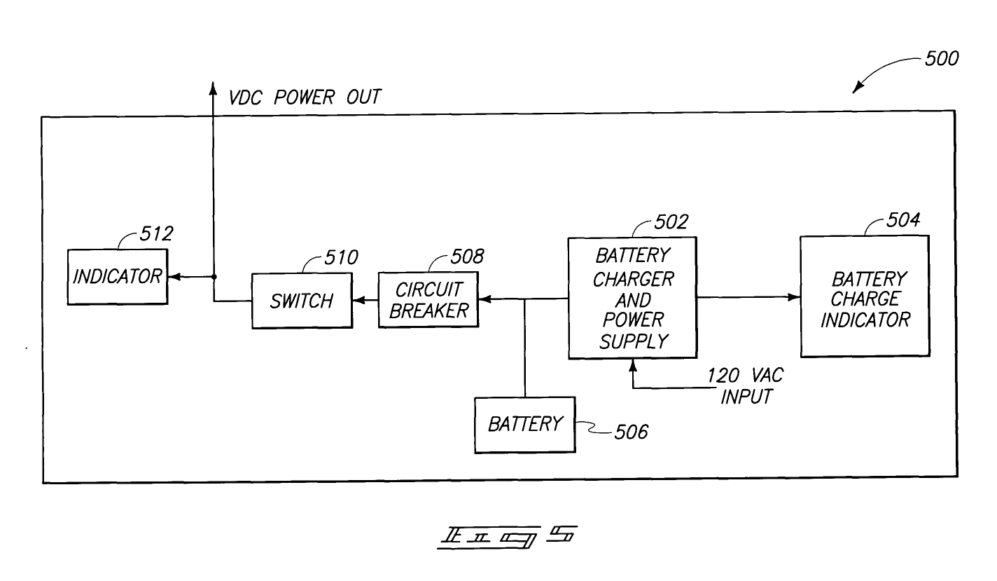

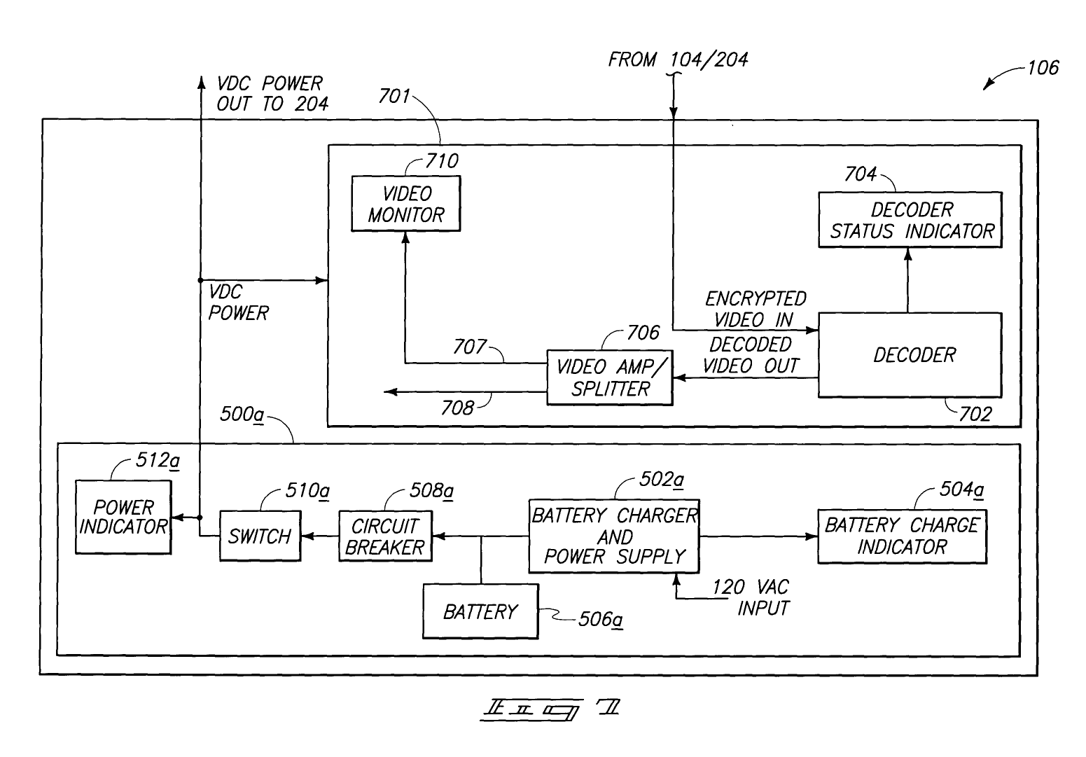

Video signals output from the receiver 406 may be provided to monitoring unit 106 (FIG. 1) for purposes of monitoring and display by personnel located remote from the camera apparatus 102. Further, details of the monitoring unit 106 are set forth below at FIG. 7. Power supply to the receiver apparatus 104 is provided from a battery source provided in a power relay box 500 (FIG. 5). In one embodiment, the power relay box 500 may be provided within receiver apparatus 104 or outside of the receiver apparatus, as desired. Further details of the power relay box 500 are described below at FIG. 5.

FIG. 4A is a block diagram schematic of an extension link receiver apparatus 202 in accordance with other embodiments of the invention, wherein elements like those illustrated in FIG. 4 are identified using like reference numerals, but with a suffix “a” added. The receiver apparatus 202 includes an antenna array 402a having a plurality of antennas 403a, 404a, 405a, a receiver 406a, a video amplifier/splitter 408, a transmitter 412, an isolator 414, and an antenna 416. Description of antenna array 402a and receiver 406a is similar to that provided as above with respect to FIG. 4, and therefore will not be repeated.

The video amplifier/splitter 408 is configured to receive and split the composite video signal output from receiver 406a into a plurality of feeds indicated by reference numerals 409 and 410. In some embodiments, video signals from video amplifier/splitter 408 (feed 410) may be provided to the monitoring unit 106 (FIG. 1) for monitoring and display. In other embodiments, video signals from video amplifier/splitter 408 (feed 409) may be provided to transmitter 412 for further transmission. In some other embodiments, video signals from video amplifier/splitter 408 may be monitored (e.g., connecting a monitoring unit 106 at feed 410) and further transmitted (e.g., feed 409 transmitted using transmitter 412). The further transmitted video signals may be subsequently received for further monitoring.

Power supply to receiver apparatus 202 may be provided from power relay unit 500a. In some embodiments, power replay unit 500a may be provided in the monitoring unit 106a. The power relay unit 500a may also be disposed outside the monitoring unit 106a, as desired. Further details of the monitoring unit 106 are set forth below with regard to FIG. 7.

Splitting of video signals by splitter 408 into a plurality of feeds (e.g., 409 and 410) may be performed if further transmission of video signals received by the receiver apparatus 202 is desired while providing a capability to monitor video signals output from video amplifier/splitter 408 (feed 410). However, if further transmission of video signals output from receiver 406a is not desired, then such video signals may be fed directly to the monitoring unit 106 for purposes of monitoring and display as described at FIG. 4. If further transmission of video signals received by receiver 202 is desired as noted above, then video signals at feed 409 are fed into transmitter 412 for further transmission. Transmitter 412 is configured to convert video signals received via feed 409 into RF signals. In an exemplary embodiment, transmitter 412 may be configured to transmit RF signals at a frequency of about 2.4 GHz. RF signals from transmitter 412 are passed through isolator 414 which is configured to protect the transmitter 412 from reflected power surges due to inadvertent removal of antenna 416. RF signals output from the isolator 414 are transmitted wirelessly using antenna 416 (e.g., patch antenna).

FIG. 5 is a schematic of a power-relay box 500 configured to supply DC power to receiver apparatuses 104 and 202 of communication systems 100 and 200, respectively. In one embodiment, the power relay box 500 includes a battery charger and power supply unit 502, a battery charge indicator 504, a battery 506, a circuit breaker 508, a power switch 510, and a power indicator device 512.

Unit 502 is configured to receive power supply from an external source (e.g., 120 volts AC supply) and charge the battery 506, when desired. Unit 502 may be implemented as a charging circuitry (not shown).

Indicator 504 is configured to an indication about the charging status of the battery 506. For example, indicator 504 may be configured as an LED, and a display of red color on the indicator 504 may indicate that a fault exists in unit 502, a display of green color on the indicator 504 may indicate that the battery has been completely charged by unit 502, and a display of amber color on the indicator 504 may indicate that the battery is currently being charged by unit 502.

Circuit breaker 508 may be provided to ensure supply of a constant output voltage from the battery 506. In the event of a power surge, the circuit breaker 508 may be configured to trip, thereby opening the circuit to disable supply of power from the battery 506.

A power switch 510 may be used to control supply of voltage from the battery 506.

An indicator 512 is provided to display an indication of voltage supply from the battery 506. For example, a red display by the indicator 512 may indicate that no voltage is being supplied from the battery 506, and a green display may indicate that voltage is being supplied from the battery 506.

FIG. 6 is a block diagram schematic of extension link receiver apparatus 204 shown in FIG. 2. In one embodiment, the receiver apparatus 204 includes an antenna 602 (e.g., a patch antenna), and a receiver 604. RF signals transmitted by transmitter 412 (FIG. 4A) are received by the receiver 604 via antenna 602. In one case, antenna 602 has a gain of about 14 dB. The receiver 604 converts the received RF signals into composite video signals. Video signals output from the receiver 604 may be received by the monitoring unit 106 (FIG. 2) via a cable. Other ways of providing video signals from the receiver apparatus 204 to the monitoring unit 106 are possible (e.g., wireless or optical transmission). Further details of the monitoring unit 106 are set forth below with regard to FIG. 7.

FIG. 7 is a block diagram schematic of a monitoring unit 106 in accordance with one embodiment. The monitoring unit 106 may be used for purposes of monitoring and display of video signals from receiver apparatuses 104 or 204 in accordance with various embodiments of the invention as set forth in FIGS. 1-2. In one embodiment, monitoring unit 106 includes a monitoring device 701 and a power relay unit 500a, wherein like elements shown in FIG. 5 are identified using like numerals, but a suffix “a” added. The monitoring unit 106 may be used in the following cases:

Case 1

In the embodiment shown in FIG. 4, encrypted video signals may be output from the receiver 406 and provided as input to decoder 702 of the monitoring unit 106.

Case 2

In the embodiment shown in FIG. 4A, encrypted video signals may be output as video signal feed 410 and provided as input to decoder 702 of the monitoring unit 106.

Case 3

If encrypted video signals are further transmitted using transmitter 412 as shown in FIG. 4A, and received using the receiver apparatus 204 (FIG. 6), encrypted video signals output from receiver 604 (FIG. 6) may be provided as input to decoder 702. After encrypted video signals are received by decoder 702, the rest of the operation of the circuitry shown in FIG. 7 is common to the above noted cases 1-3, and will be described below.

In one embodiment, the monitoring device 701 includes a decoder 702, a decoder status indicator 704, a video amplifier/splitter 706, and a video monitor 710.

Decoder 702 is configured to decrypt encrypted video signals received as input by the decoder 702. Decrypted video signals are provided to a video amplifier/splitter 706.

Decoder status indicator 704 may be a display indicator (e.g., LED diode, etc.) to display decoding status of encrypted video signals by decoder 702.

Video amplifier 706 may be configured to amplify split video signals received from decoder 702 into a plurality of feeds indicated by reference numerals 707 and 708. Video signals indicated at feed 707 may be displayed on a monitor 710, and video signals indicated at feed 708 may be provided to a video recording device (e.g., VCR, DVD recorder, etc.) (not shown) for recording purposes.

Power supply to monitoring device 701 is provided by power relay box 500a. In one embodiment, the power delay box 500a may be provided within the monitoring unit 106. Details of the power relay box 500 were described above at FIG. 5, and therefore will not be repeated.

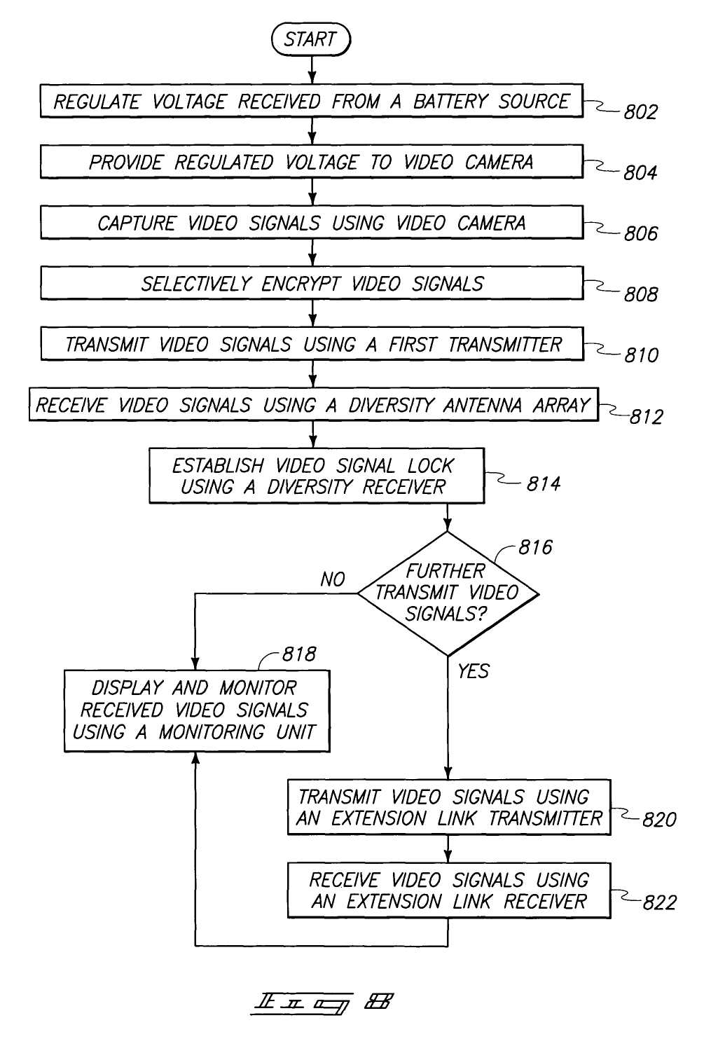

FIG. 8 is a flowchart describing a methodology of transmitting video signals between remote locations in accordance with some embodiments of the invention.

At a step 802, voltage received from a battery source (e.g., battery 315) is regulated. Step 804 is then performed.

At a step 804, the regulated voltage is provided to a camera (e.g., video camera 302).

At a step 806, video signals are captured using the video camera.

At a step 808, captured video signals are selectively encrypted, as desired.

At a step 810, video signals (e.g., encrypted or unencrypted) are transmitted using a first transmitter (e.g., transmitter 328).

At a step 812, the transmitted video signals are received using a diversity antenna array (e.g., antenna array 402 of receiver apparatus 104).

At a step 814, diversity receiver 406 of the receiver apparatus 104 is used to establish a lock on a video signal received by the diversity antenna array.

At a step 816, an inquiry is made to determine further transmission of video signals received by the first receiver apparatus. Step 818 is performed if no further transmission of the video signals is desired. Step 820 is performed if further transmission of the video signals is desired.

At a step 818, the received video signals are displayed and monitored using a monitoring unit.

At a step 820, the received video signals are further transmitted (e.g., using a second transmitter 412, also referred to as extension link transmitter).

At a step 822, the further transmitted video signals are received using a receiver (e.g., extension link receiver apparatus 204) and displayed for monitoring as indicated at step 818.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A communication system configured to communicate information in real-time between remote locations, comprising:
a portable camera apparatus including:
a video camera configured to capture video signals;
a voltage regulator configured to regulate voltage received from a battery source and providing a regulated voltage to the video camera; and
a transmitter configured to transmit the video signals captured by the video camera from one location to another remote location; and
a receiver apparatus including:
an antenna array having a plurality of antennas, wherein individual ones of antennas of the antenna array are configured to receive the video signals transmitted by the transmitter; and
a receiver device configured to be disposed adjacent the antenna array and configured to scan the video signals received by individual ones of the antennas of the antenna array, and wherein the receiver is further configured to establish a lock on a video signal in response to signal strength of the respective video signals received by the individual ones of the antennas of the antenna array.

2. The system of claim 1, further comprising:
a monitoring unit configured to monitor the video signals received by the receiver apparatus.

3. The system of claim 1, wherein the camera apparatus further comprises:
an encoder configured to encrypt video signals output from the video camera prior to transmission; and
a bypass switch configured to selectively control routing of video signals captured by the video camera either to the encoder or directly to the transmitter for transmission.

4. The system of claim 3, wherein the camera apparatus further comprises:
a battery;
a laser flashing apparatus disposed adjacent to the video camera, the laser flashing apparatus including:
a laser pointer to enable a remote monitoring user to identify a frame of reference in an image captured by the video camera; and
control circuitry configured to control the laser pointer to periodically turn-on and turn-off in order to conserve energy drawn from the battery and supplied to the laser flashing apparatus.

5. The system of claim 1, wherein the voltage regulator is configured to generate a plurality of regulated voltages comprising first and second regulated voltages.

6. The system of claim 5, wherein the first regulated voltage is provided to the video camera and the encoder.

7. The system of claim 5, wherein the second regulated voltage is provided to the laser flashing apparatus.

8. The system of claim 1, wherein the receiver apparatus comprises:
a second transmitter configured to further transmit the video signals output from the receiver; and
an antenna configured to transmit the video signals received from the second transmitter.

9. The system of claim 8, wherein the first mentioned transmitter is configured to transmit video signals at about 900 MHz, and the second transmitter is configured to transmit video signals at about 2.4 GHz.

10. The system of claim 8, further comprising:
a second receiver apparatus configured to receive the video signals transmitted from the second transmitter; and
a monitoring unit communicatively coupled with at least one of the first mentioned receiver apparatus and the second receiver apparatus to monitor video signals received from the first mentioned receiver apparatus and the second receiver apparatus, the monitoring unit including:
a decoder configured to decode the received video signals; and
a display device configured to display video signals decoded by the decoder.

11. The system of claim 10, wherein the second receiver apparatus comprises an antenna having a gain of at least 14 dB.

12. The system of claim 10, wherein transmission range between the first mentioned receiver apparatus and the second receiver apparatus is greater than 4 miles line-of-sight.

13. The system of claim 10, wherein the monitoring unit further comprises:
a device configured to split a video signal decoded by the decoder into first and second signals, the first signal provided to the display device configured to display the first signal, and the second signal provided to a video recording device configured to record the second signal;
a battery configured to provide power to the monitoring unit and the first mentioned receiver apparatus and the second receiver apparatus; and
a charger configured to receive power supply from an external source to charge the battery.

14. The system of claim 1, wherein the camera apparatus is disposed in a waterproof housing.

15. The system of claim 1, wherein the voltage regulator comprises a booster circuit configured to boost voltage from a first level to a higher second level.

16. The system of claim 1, wherein the receiver device comprises a tuner configured to tune the receiver device to a select transmission frequency.

17. The system of claim 1, wherein the transmitter is configured to convert video signals from the video camera into RF signals prior to transmission.

18. The system of claim 1, wherein the receiver device is configured to convert RF signals into video signals.

19. The system of claim 1, wherein the individual ones of antennas comprise a patch antenna having a gain of at least 8 dB.

20. The system of claim 1, wherein transmission range between the camera apparatus and the receiver apparatus is about 2200 feet line-of-sight without encountering signal degradation.

21. The system of claim 1, wherein the video signals are transmitted in analog mode.

22. The system of claim 1, wherein the video signals are transmitted at a power level of about 200 mW.

23. A communication system comprising:
a portable camera apparatus including:
a video camera configured to capture video signals; and
a transmitter configured to transmit the video signals captured by the video camera;
a receiver apparatus including:
an antenna array having a plurality of antennas, wherein individual ones of antennas of the antenna array are configured to receive video signals transmitted by the transmitter; and
a receiver device disposed adjacent the antenna array, wherein the receiver is configured to scan the video signals received by individual antennas of the antenna array, the receiver device further configured to establish a lock on a video signal having a highest signal strength from among the video signals received by the individual antennas, and wherein the video signals from the transmitter are transmitted at a frequency of about 900 MHz.

24. The system of claim 23, wherein the camera apparatus further comprises:
an encoder configured to encrypt the video signals received from the video camera prior to transmission by the transmitter.

25. The system of claim 23, wherein the receiver device comprises:
a second transmitter configured to further transmit the video signals received by the receiver device.

26. The system of claim 25, wherein video signals from the second transmitter are transmitted at a frequency of about 2.4 GHz.

27. The system of claim 25, further comprising:
a second receiver apparatus configured to receive the video signals transmitted by the second transmitter; and
a monitoring unit configured to receive video signals from at least one of the first mentioned receiver apparatus and the second receiver apparatus, the monitoring unit including:
a decoder configured to decode the received video signals; and
a display device configured to display decoded video signals.

28. A communication system configured to communicate information in real-time between remote locations, comprising:
a portable camera means comprising:
a camera means for capturing video signals;
means for regulating voltage received from a battery source and providing a regulated voltage to the camera means; and
a transmitter means for transmitting the video signals captured by the camera means;
a receiver means comprising:
an antenna array means having a plurality of antennas for receiving the video signals transmitted by the transmitter means; and
a receiver means disposed adjacent the antenna array means for scanning the video signals received by individual antennas of the antenna array means, and wherein the receiver means is further configured to lock onto a video signal having a highest signal strength from among the video signals received by individual antennas of the antenna array means.

29. A portable camera configured to wirelessly transmit video signals in real-time to a remote location, comprising:
a voltage regulator configured to regulate voltage received from a battery source;
an encoder configured to encrypt the video signals prior to transmission;
a transmitter configured to transmit the video signals captured by the camera; and
a module comprising:
a light source configured to identify a frame of reference in an image captured by the camera; and
circuitry for controlling the light source to periodically turn-on and turn-off in order to conserve energy drawn from the battery source.

30. The camera of claim 29, wherein the video signals are transmitted at about 900 MHz.

31. The camera of claim 29, wherein the light source comprises a laser pointer.

32. A communication method for communicating information in real-time between remote locations, comprising:
regulating a voltage received from a battery source provided in a portable video camera;
providing a regulated voltage to the video camera;
capturing video signals using the video camera;
transmitting the video signals using a transmitter;
providing an antenna array having a plurality of antennas to receive the video signals transmitted by the transmitter; and
scanning the received video signals using a receiver device disposed adjacent the antenna array, the receiver device configured to scan individual ones of antennas of the antenna array and establish a lock on a video signal in response to signal strength of the respective video signals received by the individual ones of the antennas.

33. The method of claim 32, further comprising:
selectively encrypting the video signals received from the video camera prior to transmission from the transmitter.

34. The method of claim 33, further comprising:
disposing a laser flashing apparatus adjacent the video camera to enable a remote monitoring user to identify a frame of reference in an image captured by the video camera; and
controlling the laser flashing apparatus to periodically turn-on and turn-off in order to conserve energy drawn from the battery.

35. The method of claim 32, further comprising:
providing the video signals received by the receiver device to a monitoring apparatus;
decoding the video signals received by the monitoring apparatus; and
displaying decoded video signals on a display device of the monitoring apparatus.

36. The method of claim 32, further comprising:
further transmitting the video signals received by the receiver device using a second transmitter;
receiving the further transmitted video signals in a receiver device of a monitoring apparatus;
decoding the video signals received in the receiver device of the monitoring apparatus; and
displaying the decoded video signals on a display device of the monitoring apparatus.

37. The method of claim 32, wherein transmitting the video signals comprises transmitting the video signals by the first mentioned transmitter at a frequency of about 900 MHz.

38. A communication method for communicating information between remote locations, comprising:
capturing signals using a video camera;
transmitting the captured signals using a transmitter comprised in the video camera;
receiving the video signals transmitted from the video camera using an antenna array having a plurality of antennas;
providing a receiver device adjacent the antenna array;
scanning the video signals received by individual ones of antennas of the antenna array to determine a video signal having a highest signal strength among the received video signals; and
locking onto a video signal having the highest signal strength, and wherein the video signals from the transmitter are transmitted at a frequency of about 900 MHz.

39. The method of claim 38, further comprising:
encrypting the video signals captured by the video camera prior to transmission by the transmitter.

40. The method of claim 38, further comprising:
further transmitting the video signal having the highest signal strength;
receiving the video signal of the highest signal strength in a second receiver;
decoding the video signal received in the second receiver; and
displaying decoded video signals on a display device.

41. The method of claim 40, wherein the further transmitting is performed at a frequency of about 2.4 GHz.

42. A method of remotely monitoring a hazardous environment, comprising:
providing a water-proof camera apparatus in the hazardous environment to capture and transmit video signals of the hazardous environment;
receiving the transmitted video signals in a receiver apparatus via an antenna array having a plurality of antennas; and
scanning the individual ones of antennas of the antenna array using the receiver apparatus to establish a lock on a video signal having a highest signal strength among the received video signals.

43. The method of claim 42, further comprising:
further transmitting the video signal of the highest signal strength using a transmitter located in the receiver apparatus;
receiving the further transmitted video signal in a second receiver apparatus; and
displaying the received video signal.

44. The method of claim 43, wherein the further transmission of the video signal is performed at a frequency of about 2.4 GHz.

45. The method of claim 42, wherein the captured video signals are selectively encrypted prior to transmission.

46. The method of claim 42, wherein transmission of the captured video signals is performed at a frequency of about 900 MHz.
